(19) United States
(12) Patent Application Publication
(10) Pub. No.: US 2006/0249917 A1
(43) Pub. Date: Nov. 9, 2006

(54) Composite sealing device

(75) Inventor: John W. Kosty, Fountain Valley, CA (US)

Correspondence Address: LARSON NEWMAN ABEL;POLANSKY & WHITE, LLP, 5914 WEST COURTYARD DRIVE, SUITE 200, AUSTIN, TX, 78730, US

(73) Assignee: SAINT-GOBAIN PERFORMANCE PLASTICS CORPORATION, Aurora, OH (US)

(21) Appl. No.: 11/400,804

(22) Filed: Apr. 7, 2006

Related U.S. Application Data
(60) Provisional application No. 60/669,577, filed on Apr. 7, 2005.

(51) Int. Cl. F16J 15/02

(52) U.S. Cl. 277/644; 277/314; 277/608

(57) ABSTRACT

An annular sealing device is provided that includes a composite material having a substantially rigid substrate with both a first major surface and a second major surface, and also of a shape where the substantially rigid substrate is configured to extend out of a plane parallel to a sealing surface at an angle. The annular sealing device also includes a polymer layer overlying at least one of the first major surface and the second major surface.

### CROSS-REFERENCE TO RELATED APPLICATION(S)

This application is a non-provisional application of and claiming priority to U.S. Provisional Application No. 60/669,577, entitled “Seal Formed From Polymer Laminated Metallic Constructions” filed Apr. 7, 2005, which is herein incorporated by reference in its entirety.

### BACKGROUND

1. Field of the Disclosure

The present disclosure is related generally to sealing devices and particularly related to composite sealing devices.

2. Description of the Related Art

Sealing devices, such as seal rings or the like, are well known in the art for providing a seal between opposing sealing surfaces. Various sealing devices can be used to provide a leak-tight seal between surfaces that are static with respect to one another, and/or between surfaces that are dynamic relative to one another, e.g., between a static surface and a dynamic surface, or between two sealing surfaces. An exemplary dynamic sealing application is a seal that is disposed between a static housing and a dynamic rotary or reciprocating sealing surface.

Such seal devices can be configured differently, depending on the specific sealing application. For example, seal rings can be configured in the form of a lip seal, comprising one or more lip elements that are designed to project away from the seal body to make contact with the dynamic sealing surface, or in the form of an energized seal, comprising one or more seal elements that are pressed into contact with a dynamic sealing surface by an energizing member disposed within the seal ring. Such seal rings can be used for oil or non-oil sealing applications, or for any type of gas or fluid sealing application.

Energized seals are well known in the art, and are typically constructed to include a seal body formed from either a metallic or nonmetallic material, depending on the particular seal application, and an energizing member positioned within the seal body to urge a portion the seal body into contact with the dynamic sealing surface. See, for example, U.S. Pat. Nos. 6,619668 and 5,163,692. Also known is the use of structures utilizing multiple layers or multiple materials. See, for example, U.S. Pat. Nos. 5,380,019, 6,830,641, and 5,573,846. In some cases an energized seal comprises an annular-shaped seal body that is formed from a polymeric material, and a patterned or individually formed metallic material that is disposed within a channel defining the U-shape of the seal body. Depending on the specific sealing application, such U-shaped seals can be used to provide a radial sealing surface, e.g., between a radially aligned dynamic sealing surface and an inside or outside diameter surface of the seal body, or to provide an axial seal surface, e.g., between an axially aligned dynamic sealing surface and an inside or outside diameter surface of the seal body.

Generally when forming known lip seals and energized seals, multiple steps are required to form the different seal members. Generally, the patterned member and the body member are manufactured separately or at least provided or joined in two different steps. Individual construction processes for each of the components as well as assembly requirements results in a time consuming and labor intensive expenditure.

Accordingly, the industry continues to require seal devices having simplified construction and fabrication without compromising sealing performance when compared to conventional seals. Additionally, the industry continues to require seals that provide improved seal effectiveness and durability.

### SUMMARY

According to a first aspect, an annular sealing device is provided that includes a composite material made of a substantially rigid substrate having a first major surface and a second major surface, wherein the substantially rigid substrate is configured to extend out of a plane parallel to a sealing surface at an angle. The composite material of the sealing device also includes a polymer layer overlying at least one of the first major surface and the second major surface.

Referring to a particular application, according to another aspect, a reservoir configured to receive a volume of liquid is provided. The reservoir includes a major surface, a drain hole in the major surface, and a plug disposed within the drain hole. The plug includes a shaft and a composite sealing device around a portion of the shaft. The composite sealing device includes a substantially rigid substrate having a first major surface and a second major surface and a polymer layer overlying the first major surface and the second major surface, as well as a gripping edge made of the polymer layer that provides a radial force on the shaft.

According to another aspect, a method of forming a seal is provided. The method includes the steps of providing a fastener comprising a head and a shaft and disposing a composite sealing device around the shaft. As with previously described embodiments, the composite sealing device can include a substantially rigid substrate having a first major surface, a second major surface, and a polymer layer overlying at least one of the first major surface and the second major surface. The method further includes the steps of providing a sealing surface having an opening therein and inserting the shaft into the opening, wherein the composite sealing device extends out of a plane parallel to the sealing surface at an angle, and engaging the sealing surface with the composite sealing device.

### BRIEF DESCRIPTION OF THE DRAWINGS

The present disclosure may be better understood, and its numerous features and advantages made apparent to those skilled in the art by referencing the accompanying drawings.

FIG. 1 is a cross sectional illustration of a portion of a sealing device according to a particular embodiment.

FIG. 2 is a top-down perspective illustration of a sealing device according to a particular embodiment.

FIG. 3 is a cross sectional illustration of a sealing device on a shaft according to a particular embodiment.

FIG. 4 is a cross sectional illustration of a sealing device on a shaft according to a particular embodiment.

FIG. 5 is an illustration of a sealing device in a particular application according to a particular embodiment.

FIG. 6 is a flow chart illustrating a method of forming a seal according to a particular embodiment.

The use of the same reference symbols in different drawings indicates similar or identical items.

### BRIEF DESCRIPTION OF THE DRAWINGS

Referring to FIG. 1, a cross-sectional illustration of a portion of a sealing device according to one embodiment is depicted. As is illustrated, the sealing device can be a composite material including a substantially rigid substrate 101, which can be made of various pliable materials depending on the desired application. According to one embodiment, the substantially rigid substrate 101 can be made of a metal, a metal alloy, or a combination thereof. For example, suitable metals can include steel, aluminum, titanium, stainless steel, conventional drawing-quality sheet steel, spring metals, brass or other alloys. The substantially rigid substrate 101 has two major surfaces, each of which may be left untreated or may be treated using various techniques such as galvanizing, chromate or phosphate treatments, anodizing, mechanical sandblasting or etching, and/or chemical pickling.

Moreover, as illustrated in FIG. 1 (and illustrated in subsequent Figures) the substantially rigid substrate 101 can be a continuous sheet of material, having a substantially consistent thickness and geometry through the depicted cross-section. As illustrated in FIG. 1, the cross-sectional geometry of the substantially rigid substrate 101 can be such that it generally has a substantially rectangular cross-section that substantially consistent throughout the entire circumference of the substrate (i.e. unpatterned) as opposed to a patterned, etched, or shaped substrate. The substantially rectangular cross-section can provide consistent mechanical properties throughout the sealing device. The substantially consistent and rectangular cross-sectional geometry of the substantially rigid substrate 101, in combination with other features, can facilitate a seal device that provides improved sealing performance.

In the embodiment illustrated in FIG. 1, the substantially rigid substrate 101 is disposed between two polymer layers 103 and 104. In alternative embodiments (not shown), a polymer layer can be provided on only one of the major surfaces of the substantially rigid substrate. Generally, the polymer layers 103 and 104 can be provided on the major surfaces of the substantially rigid substrate 101 as a laminate, that is, a layer of material that can be obtained from a sheet of material that has been skived or shaved to produce a polymer sheet having a fine thickness, such as about 1.0 mm thick or less. The substantially rigid substrate 101 can then be laminated with the polymer sheet, such that the polymer overlies at least a major surface of the substantially rigid substrate as a sheet of material.

Suitable polymer materials useful for forming the laminated construction can be organic polymers that facilitate properties such as self-lubrication, wear-resistance, mechanical strength, and the like. Polymer materials that can be bonded to the rigid substrate 101 include but are not limited to polypropylene; polyethylene; nitrile elastomers; fluoropolymers such as polytetrafluoroethylene (PTFE), fluorinated ethylene-propylene (FEP), perfluoroalkoxy fluorocarbon resin (PFA), polychlorotrifluoroethylene (PCTFE), ethylenechlorotrifluoroethylene copolymer (ECTFE), ethylenetetrafluoroethylene copolymer (ETFE), polyvinylidene fluoride (PVDF), polyvinyl fluoride (PVF); acetal; polycarbonate; polyimides; polyetherimide; polyether ether ketone (PEEK); polysulfones (e.g., polyethersulfone); polyamide (Nylon); polyphenylene sulfide; polyurethane; polyester; polyphenylene oxide; and blends (e.g., copolymers) and alloys thereof.

Additionally, the polymer material can include one or more fillers and/or pigments, to provide certain desired seal performance properties, such as mechanical strength, lubricity, thermal and/or electrical conductivity, wear resistance, or appearance, i.e., color. For example, the polymer layers 103 and 104 can include materials such as graphite for improved wear resistance and lubricity. Other filler materials can include, but are not limited to, carbon, aluminum oxide, ceramic materials, glass, bronze, molybdenum disulfide, silicon carbide, aromatic polyester, fluoropolymer, and mixtures thereof. It will be appreciated that the proportion of fillers and/or pigments within the polymer material can vary depending on the type of polymer material selected, and the particular type of seal application.

Affixing the polymer layers 103 and 104 to the substantially rigid substrate 101 can be accomplished by bonding such as by use of a suitable bonding agent that is interposed between the two layers. Suitable bonding agents include fluoropolymers such as PFA, MFA, ETFE, FEP, PCTFE, PVDF, curing adhesives such as epoxy, polyimide adhesives, and lower temperature hot melts such as EVA and polyether/polyamide copolymer (Pebox). For a particular example, where the polymer is PTFE, a suitable bonding agent can be any one of a number of high-temperature thermoplastic film materials, such as PFA and ETFE.

Optionally, an additional rigid mesh layer, such as a bronze metal mesh layer, can be introduced between the substantially rigid substrate 101 and the polymer laminate layers 103 and 104. The process of forming the composite material can include heat and pressure treatment to bond the polymer laminate and the substantially rigid substrate 101. Additionally, a rigid backing layer, such as a metal backing layer can be affixed to the composite material for improved durability and formability. Typically the metal backing can overlie the substantially rigid substrate 101. According to a particular embodiment, the polymer laminated construction is in the form of a PTFE laminated metal sheet, such as NORGLIDE® material, commercially available from the Saint Gobain Performance Plastics Corporation.

In reference to the geometries of the composite material and component layers, according to one embodiment, the average total thickness of the composite is not greater than about 10.0 mm, such as not greater than about 8.0 mm, or not greater than about 5.0 mm. In some embodiments, the average total thickness of the composite is not greater than about 1.0 mm. As will be appreciated, the average total thickness of the composite is dependent in part upon the average total thickness of the substantially rigid substrate 101, which according to one embodiment is not greater than about 10.0 mm, such as not greater than about 8.0 mm, or even not greater than about 5.0 mm. Accordingly, the average total thickness of the composite is also dependent, in part, upon the average total thickness of the polymer layers 103 and 104. According to one embodiment, the average total thickness of the polymer layer 103 is not greater than about 1.0 mm, such as not greater than about 0.8 mm, or even not greater than about 0.5 mm. Such thicknesses, particularly the thicknesses of the polymer layers 103 and 104, can facilitate effective sealing and reduced flow of contact materials (e.g. polymer layers) during sealing. Moreover, the ratio between the thickness of the substantially rigid substrate 101 and the thicknesses of the polymer layers 103 and 104 can improve sealing capabilities and reduce wear of the composite material due to differences in thermal expansion coefficients.

In reference to the shape of the sealing device 100, according to one embodiment, the sealing device has a generally open conical shape. As illustrated in FIG. 1, the portion of the sealing device can be tilted at an angle. According to one embodiment, the sealing device extends out of a plane, at an angle denoted as SD_{A}, to a sealing surface 105 (potentially one of two sealing surfaces). Generally, angle SD_{A} is acute and facilitates engagement of the sealing device with the sealing surface. According to a particular embodiment, the composite sealing device 100 is formed such that it extends out of a plane and at an angle of not less than about 10° relative to the sealing surface 105. That is, the sealing device 100 can extend out of a plane at an angle SD_{A} of not less than about 15°, such as not less than about 20°, for example, about 30°, or even about 40°. Still, according to one embodiment, the sealing device 100 extends out of a plane at an angle SD_{A} to the sealing surface 105 within a range of between about 15° and about 85°. The provision of the sealing device 100 having an open conical shape such that it is positioned at an angle to a sealing surface 105 can provide an energizing force both against a sealing surface as well as against a shaft during sealing, which can facilitate and effective seal. Additionally, the angle SD_{A} can be altered by selecting particular materials to form the composite. For example, selecting a substrate material having suitable physical properties (e.g. yield strength) can provide an effective energizing force against the sealing surface and the shaft during sealing. The angle SD_{A} is also related to the height 111 of the seal device, which can be altered by selecting particular materials of the composite device. Generally, the height 111 can be not greater than about 5.0 times the dimension of the thickness of the composite device, such as not greater than about 3.0 times the dimensions of the thickness of the composite device, and generally not greater than about 2.0 times the dimensions of the thickness of the composite device.

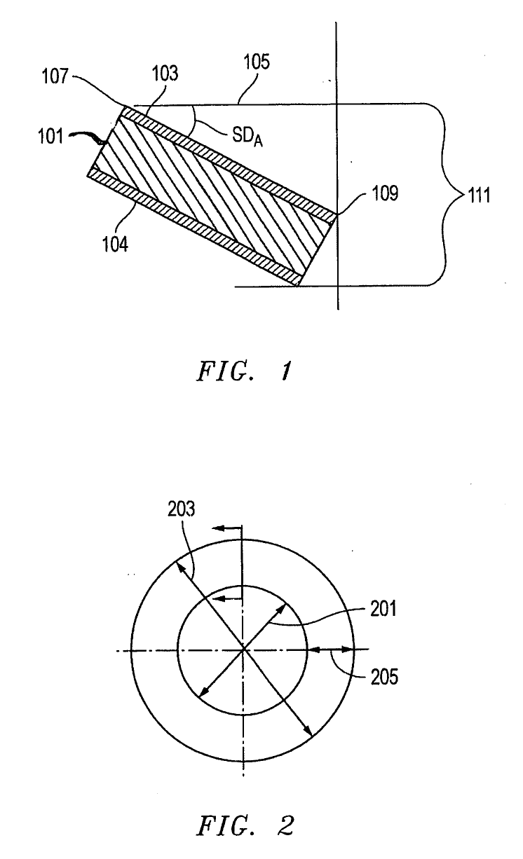

In further reference to the shape of the sealing device, as mentioned above, the sealing device can have an open conical shape or a frustoconical shape such that it has a substantially circular or annular shape when viewed from a top-down perspective (see FIG. 2). Moreover, as illustrated and according to one embodiment, the sealing device 100 is a lip-less device, such that no substantial projections are shaped from the substantially rectangular cross-section. As further illustrated in FIG. 1, the composite sealing device can have a leading edge 107 closest to the sealing surface 105, which is typically the first portion of the sealing device 100 to contact the sealing surface 105. According to a particular embodiment and as illustrated in FIG. 1, the leading edge 107 is made of the polymer material, and in some embodiments, the edge of the polymer layer 103 is the leading edge 107. Accordingly, the leading edge 107 ensures engagement of the sealing device 100 with the sealing surface 105 and facilitates uniform pressure applied to the sealing device 100 during engagement. The leading edge 107 can be facilitated by the formation of a sealing device having an open conical shape with a substantially rectangular cross-section that is substantially consistent throughout the entire circumference.

As described previously, according to a particular embodiment, the seal device 100 can have an open conical shape of an annular contour having a circular perimeter with an opening defining an inner circumference, illustrated in a top-down view of FIG. 2. However, the general the shape and size of the seal can vary depending upon the intended application. In the particular context of an annular shape illustrated in FIG. 2, the outer diameter 203 is typically not less than about 1.0 mm, such as not less than about 2.0 mm, or even not less than about 3.0 mm. Additionally, the inner diameter 201 is not less than about 0.5 mm, such as not less than about 0.75 mm, or even not less than about 1.0 mm. Generally, the outer diameter 203 can be within a range of between about 4.0 mm to about 300 mm, and particularly within a range of between about 10 mm and about 200 mm. The inner diameter 201 can generally be within a range of between about 1.0 mm and about 200 mm, such as between about 5.0 mm and about 100 mm. It will be appreciated that the ratio of the outer diameter 203 to the inner diameter 201 can be selected to provide a selected energizing force and facilitate an effective seal. Moreover, in various embodiments, the width of the seal surface 205 is half of the difference between the dimension of the outer diameter 203 and the dimension of the inner diameter 201. A suitable width of the seal surface 205 can facilitate an effective seal. As such, in certain embodiments, the width of the seal surface is typically not less than about 3.0 mm mm, such as not less than about 5.0 mm, or not less than about 10 mm.

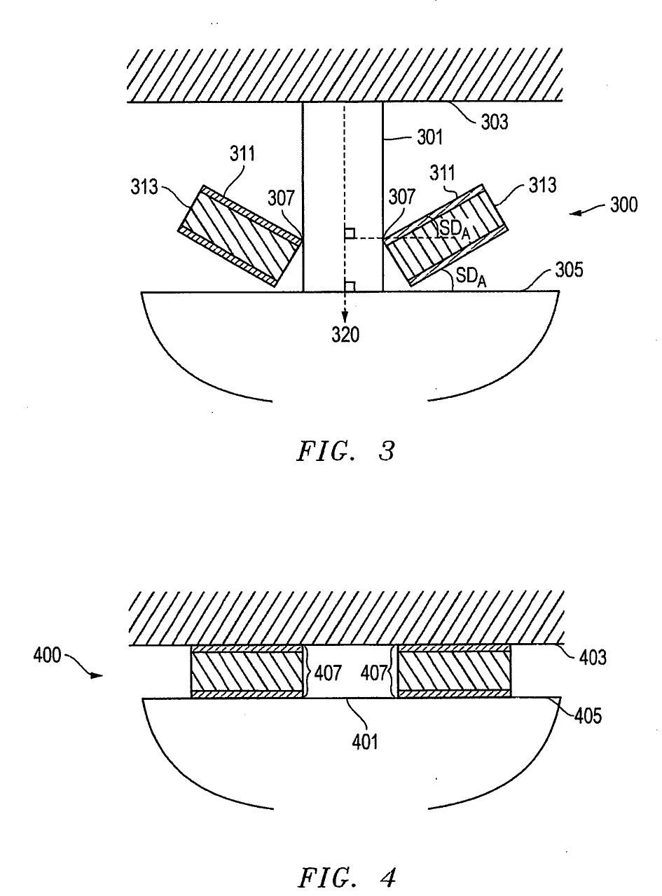

The open conical shape having an annular contour can facilitate coupling the seal device around a shaft. As illustrated in FIG. 3, a cross-sectional illustration of the composite sealing device 300 is disposed around a shaft 301 and configured to engage a first sealing surface 303. In a particular embodiment, the composite sealing device 300 can be disposed around a shaft 301 of a threaded fastener, such as a bolt or screw. When disposed around the shaft 301, the composite sealing device 300 can be resting on a second sealing surface 305, which can be the head of a fastener. In this embodiment, the composite sealing device 300 rests on the second sealing surface 305 at an angle SD_{A}. According to the particular embodiment shown, the composite sealing device 300 is disposed at an angle SD_{A} to the perpendicular of the longitudinal axis 320 of the shaft 301.

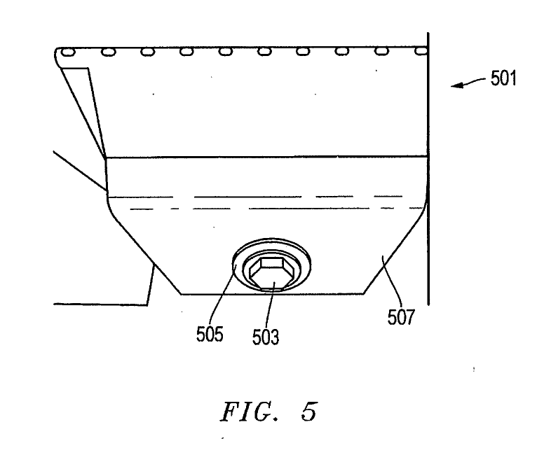

In further reference to the composite sealing device of FIG. 3, in one embodiment, edge 307 can be a gripping edge. The gripping edge 307 can extend along an inner radius of the shaft 301 and provide a radial force or energizing force on the shaft 301. According to a particular embodiment, the gripping edge 307 is made of the polymer material of the polymer layer 311. The polymer material of the gripping edge 307, as opposed to the material of the substrate 313, can provide an effective surface to engage the shaft 301 and provide an energizing force around the circumference of the shaft 301. The energizing force provided around the circumference of the shaft 301 by the gripping edge 307 can facilitate a proper engagement of the composite sealing device 300 around the shaft 301 and moreover can ensure the proper positioning of the composite sealing device 300 before engagement with the first sealing surface 303. Referring to FIG. 4, the composite sealing device 400 is illustrated after forming a seal between the first sealing surface 403 and the second sealing surface 405. Upon sealing, the composite sealing device 400 can change shape from an open conical shape (as illustrated in FIG. 3) to a substantially cylindrical shape (or tubular shape) under the sealing force exerted by the substantially parallel sealing surfaces 405 and 403. According to the illustrated embodiment, upon forming a seal, the sealing surfaces 403 and 405 are substantially parallel and, unlike in the unsealed state illustrated in FIG. 3, the major surfaces of the composite seal device 400 are parallel with the sealing surfaces 403 and 405. Upon changing shape, the composite seal device 400 can exert a force on the sealing surfaces 403 and 405 and the shaft 401. In particular, the composite sealing device 400 can exert a force on the first sealing surface 403 as a result of changing shape. Additionally, the composite sealing device 400 exerts a force on the shaft 401 via an inner radial surface as a result of changing shape. The forces exerted by the composite seal device 400 on the surrounding sealing surfaces 403 and 305 and shaft 401 can facilitate an improved seal. Moreover, the combination of the materials, the placement of the materials in contact with sealing surfaces 403 and 405, and the energized shape of the composite sealing device 400 can facilitate an improved seal and improved durability.

FIG. 5 illustrates another aspect and depicts a reservoir 501 having a bolt 503 and a composite sealing device 505 disposed between the bottom surface of the reservoir 507 and the bolt 503. According to one embodiment, the reservoir 501 is an oil pan and the bolt 503 coupled with the composite sealing device 505 is a plug for the oil pan. In accordance with previous embodiments, the composite sealing device 505 can be a metal and polymer composite having an open conical shape prior to engaging sealing surfaces. Also, as described in accordance with previous embodiments, the composite sealing device can be an energized seal, such that a gripping edge provides a radial force on a portion of the shaft of the bolt 503 prior to sealing so that the composite sealing device maintains a precise position on the bolt 503. Additionally, in accordance with previous embodiments, after sealing, the composite sealing device 505 changes shape and exerts a force against the shaft of the bolt 503 and the bottom surface of the reservoir 507 otherwise referred to as a sealing surface. It will be appreciated, that in accordance with embodiments described herein, the composite sealing device 505 can be suitable for sealing a reservoir 501 that can contain a range of liquids, such as corrosive liquids, acids, bases, or alternatively, common liquids such as water.

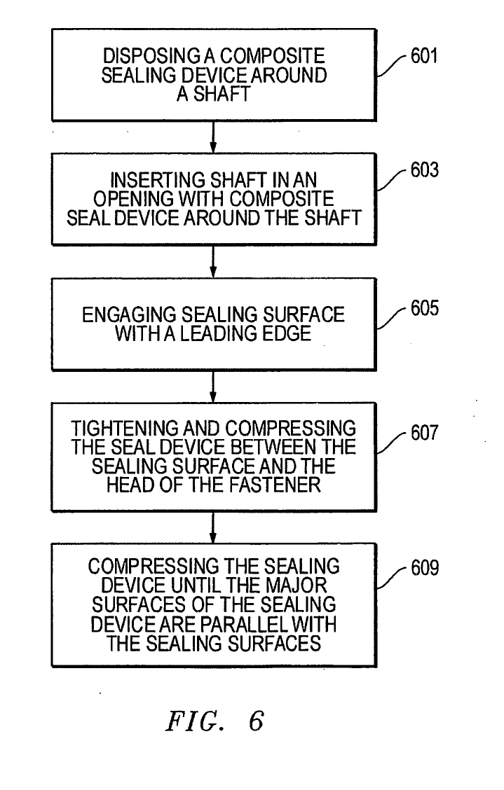

Referring to FIG. 6, a flow chart illustrates a method of forming a seal. Initially, the method can include disposing a composite sealing device around a shaft 601. The shaft can be part of a fastener, such as a bolt or screw, and the shaft of the fastener can be placed in an opening with the composite sealing device disposed around the shaft between the head of the fastener and the surface to be sealed 603. The composite sealing device can be formed by a punching or press mechanism to form the energized seal having an open conical shape. Additionally, the composite material can be provided as a sheet of composite material, such that the formation of the composite seal device requires a single forming step, such as punching the sheet of composite material. As previously described, the composite sealing device can be an energized seal with a gripping edge to engage and exert a radial force around a portion of the shaft, which facilitates proper engagement of the composite sealing device around the shaft and ensures the proper positioning of the composite sealing device before engagement with the first sealing surface.

After inserting the shaft into the opening 603, the fastener can be tightened against the sealing surface such that the leading edge of the composite sealing device engages the sealing surface 605. In an exemplary embodiment, prior to engagement with the sealing surface the composite sealing device generally has an open conical shape and sits at an angle to the sealing surface. Because, with the illustrated embodiment, the composite sealing device sits at an angle to the sealing surface and has a substantially consistent rectangular cross section throughout the entire circumference, the illustrated composite sealing device has a leading edge for first engaging the sealing surface.

Upon tightening of the fastener to form a seal with the sealing surface the composite sealing device can be compressed between the head of the fastener and the sealing surface 607. Compression of the composite sealing device can change the shape of the device such that it changes from an open conical shape to a substantially cylindrical shape. In such instances, the major surfaces of the composite sealing device are substantially parallel with the sealing surface and the surface of the head of the fastener, which can be considered a second sealing surface 609. Moreover, compression of the composite sealing device can include compressing the device such that an inner radial surface of the composite sealing device fully contacts the shaft for an effective seal. Additionally, the composite sealing device can exert forces against the sealing surface and the shaft for an effective leak-tight seal.

It will be understood that each of the elements described above, or two or more together, may also find utility in applications differing from the types described herein. While the invention has been illustrated and described as embodied in a composite sealing device, it is not intended to be limited to the details shown, since various modifications and substitutions can be made without departing in any way from the spirit of the present invention. For example, although many examples of potential materials of construction have been presented throughout this specification, the omission of a material is not intended to specifically exclude its use in or in connection with the claimed invention. As such, further modifications and equivalents of the invention herein disclosed may occur to persons skilled in the art using no more than routine experimentation, and all such modifications and equivalents are believed to be within the spirit and scope of the invention as defined by the following claims.

1. An annular sealing device comprising:
a composite material comprising:
a) a substantially rigid substrate having a first major surface and a second major surface, wherein the substantially rigid substrate is configured to extend out of a plane parallel to a sealing surface at an angle; and
b) a polymer layer overlying at least one of the first major surface and the second major surface.

2. The annular sealing device of claim 1, wherein the polymer layer is overlying the first major surface and the second major surface.

3. The annular sealing device of claim 1, wherein the polymer layer is a lanminate.

4.-5. (canceled)

6. The annular sealing device of claim 1, wherein the polymer layer comprises a fluoropolymer.

7. The annular sealing device of claim 6, wherein the fluoropolymer is polytetrafluoroethylene (PTFE).

8. The annular sealing device of claim 1, wherein the substantially rigid substrate comprises a metal, a metal alloy, or a combination thereof.

9.-10. (canceled)

11. The annular sealing device of claim 1, wherein the substantially rigid substrate is an unpatterned substrate.

12. The annular sealing device of claim 1, wherein the substantially rigid substrate extends out of plane and at an angle of not less than about 10° relative to the sealing surface.

13.-14. (canceled)

15. The annular sealing device of claim 1, wherein the composite material has an open conical shape having an annular-shaped perimeter and all opening within the annular-shaped perimeter.

16. The annular sealing device of claim 15, wherein the open conical shape is disposed around a shaft.

17.-19. (canceled)

20. The annular sealing device of claim 15, wherein the open conical shape has a substantially rectangular cross section, the substantially rectangular cross section being substantially consistent throughout an entire circumference of the open conical shape.

21. The annular sealing device of claim 15, wherein the open conical shape is oriented such that a leading edge is closest to the sealing surface.

22. (canceled)

23. The annular sealing device of claim 15, wherein the open conical shape has a gripping edge extending along an inner radius and engaging the shaft.

24. (canceled)

25. The annular sealing device of claim 23, wherein the gripping edge provides a radial force on the shaft.

26. The annular sea device of claim 1, wherein the polymer layer overlying the first major surface of the substantially rigid substrate is engaging the sealing surface after forming a seal.

27.-28. (canceled)

29. The annular sealing device of claim 26, wherein the first major surface and the second major surface are substantially parallel to each other and a sealing surface.

30. The annular sealing device of claim 26, wherein the composite material provides an energizing force against a sealing surface and a force against the shaft.

31.-32. (canceled)

33. A method of forming a seal, said method comprising the steps of:
a) providing a fastener comprising a head and a shaft;
b) disposing a composite seating device around the shaft, the composite sealing device comprising a substantially rigid substrate having a first mnajor surface and a second rajor surface and a polymer layer overlying at least one of the first major surface and the second major surface;
c) providing a sealing surface having an opening therein;
d) inserting the shaft into the opening, wherein the composite sealing device extends out of a plane parallel to the sealing surface at an angle; and
e) engaging the sealing surface with the composite sealing device.

34. The method of claim 33, wherein the polymer layer comprises a fluoropolymer.

35.-37. (canceled)

38. The method of claim 33, wherein the composite sealing device comprises a leading edge comprising the polymer layer.

39. (canceled)

40. The method of claim 33, wherein the composite sealing device comprises a gripping edge comprising the polymer layer.

41. (canceled)

42. The method of claim 40, wherein step b) comprises exerting a radial force on the sealing shaft with the gripping edge.

43. (canceled)

44. The method of claim 33, wherein the substantially rigid substrate extends out of plane and at an angle of not less than about 10° relative to a sealing surface prior to engaging the sealing surface.

45. (canceled)

46. The method of claim 33, wherein step e) further comprises compressing the composite sealing device such that an inner radial surface of the composite sealing device fully contacts the shaft.

47. The method of claim 33, wherein step e) ftrther comprises compressing the composite sealing device such that the first major surface and the second major surface are substantially parallel to each other and the sealing surface.

48. (canceled)

49. A reservoir configured to receive a volume of liquid, the reservoir comprising:
a major surface;
a drain hole in the major surface; and
a plug disposed within the drain hole, the plug comprising a shaft and a composite sealing device around a portion of the shaft, wherein the composite sealing device comprises a substantially rigid substrate having a first major surface and a second majo surface and a polymer layer overlying the first major surface and the second major surface, the composite sealing device f er comprising a gripping edge comprising the polymer layer, the gripping edge providing a radial force on the shaft.

50. (canceled)
